(19) United States
(12) Patent Application Publication
(10) Pub. No.: US 2025/0353110 A1
(43) Pub. Date: Nov. 20, 2025

(54) JET NOZZLE HAVING A POWDER SECTION AND AN ADVANCE SECTION

(71) Applicant: TRUMPF Laser- und Systemtechnik SE, Ditzingen (DE)

(72) Inventors: Nicolai SPEKER, Pleidelsheim (DE); Björn SAUTTER, Leonberg (DE); Andreas SCHOLZ, Taunusstein (DE); Stefan BELITZ, Stuttgart (DE); Arne STECK, Remseck am Neckar (DE); Jakob SPIECKER, Stuttgart (DE); Fabian GOETZELMANN, Leonberg (DE); Tim HESSE, Ditzingen (DE); Holger BRAUN, Renningen (DE)

(21) Appl. No.: 19/280,159

(22) Filed: Jul. 25, 2025

Related U.S. Application Data
(63) Continuation of application No. PCT/EP2024/051301, filed on Jan. 19, 2024.

(30) Foreign Application Priority Data
Jan. 27, 2023 (DE) 10 2023 102 043.9
Sep. 4, 2023 (DE) 10 2023 123 704.7

(51) Int. Cl. B23K 26/144; B23K 26/14

(52) U.S. Cl. CPC B23K 26/144; B23K 26/147

(57) ABSTRACT

A jet nozzle for laser cladding along a direction of advance includes a light channel for conducting at least one laser beam directed onto a workpiece, and a powder unit located radially outside the light channel for conducting at least one jet of powder to be applied to the workpiece. The powder unit forms a powder section at a mouth of the jet nozzle in a circumferential direction about the light channel. An advance section that is devoid of the powder unit is contiguous thereto in the circumferential direction.

### CROSS REFERENCE TO RELATED APPLICATIONS

This application is a continuation of International Application No. PCT/EP2024/051301 (WO 2024/156620 A1), filed on Jan. 19, 2024, and claims benefit to German Patent Application No. DE 10 2023 123 704.7, filed on Sep. 4, 2023 and to German Patent Application No. DE 10 2023 102 043.9, filed on Jan. 27, 2023. The aforementioned applications are hereby incorporated by reference herein.

### FIELD

Embodiments of the present invention relate to a jet nozzle for laser cladding along a direction of advance.

### BACKGROUND

Laser cladding is used in the fields of repair, coating, and/or joining technology, for example. A distinction can be drawn between conventional laser cladding techniques (laser metal deposition (LMD), direct metal deposition (DMD) or direct energy deposition (DED)), and high-speed laser cladding (high-speed laser metal deposition (HS-LMD) or extreme high-speed laser application (EHLA)). HS-LMD methods are described, for example, in published patent applications DE 10 2011 100 456 A and DE 10 2018 130 798 A1. Another laser cladding method is known from Chinese patent application CN 109175372 A.

Laser cladding can be used to apply a functional layer to a workpiece. This generally increases the load-bearing capacity of a workpiece that has undergone laser cladding compared to a workpiece that has not. The functional layer may serve as a wear protection layer, for example. Application of the functional layer is based on melting of a workpiece surface, application of a powdered filler material and subsequent cooling, such that a matrix structure with hard material particles is materially bonded to the material surface. Laser cladding therefore acts on the internal material structure of the workpiece and changes it. Under certain circumstances, this may result in imperfections in the internal material structure. These may impair the desired increase in load-bearing capacity. The imperfections may be of a microscopic nature, so meaning that they can only be identified with great effort.

### SUMMARY

Embodiments of the present invention provide a jet nozzle for laser cladding along a direction of advance. The jet nozzle includes a light channel for conducting at least one laser beam directed onto a workpiece, and a powder unit located radially outside the light channel for conducting at least one jet of powder to be applied to the workpiece. The powder unit forms a powder section at a mouth of the jet nozzle in a circumferential direction about the light channel. An advance section that is devoid of the powder unit is contiguous thereto in the circumferential direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a jet nozzle during laser cladding according to some embodiments;

FIG. 2 shows a side view of a jet nozzle according to some embodiments;

FIG. 3 shows a perspective view of the jet nozzle of FIG. 2 according to some embodiments;

FIG. 4 shows the jet nozzle of FIG. 2 connected to other components according to some embodiments;

FIG. 5 shows a plan view of a distal region of the jet nozzle of FIG. 2 according to some embodiments;

FIG. 6 shows a plan view of a flange section of the jet nozzle of FIG. 2 according to some embodiments;

FIG. 7 shows a further perspective view of the jet nozzle of FIG. 2 according to some embodiments;

FIG. 8 shows a perspective sectional view of the jet nozzle of FIG. 2 according to some embodiments;

FIG. 9 shows a further plan view of the distal region of the jet nozzle of FIG. 2 according to some embodiments;

FIG. 10 shows a plan view of the distal region of the jet nozzle with a process gas unit according to some embodiments;

FIG. 11 shows a side view of a further embodiment of the jet nozzle with a geometrically adapted mouth of the nozzle; and

FIG. 12 shows a plan view of a further embodiment of the jet nozzle with a geometrically adapted mouth of the nozzle.

### DETAILED DESCRIPTION

Embodiments of the present invention provide an improved jet nozzle for laser cladding along a direction of advance. Embodiments of the invention can increase the welding quality of a deposited functional layer and of the workpiece as a whole, and to reduce or avoid imperfections in a welded joint between a powdered filler material and a material surface. The imperfections may be bonding defects between the material surface and the applied functional layer or between individual applied functional layers. The imperfections may also be pores, i.e., air pockets, which occur within the applied functional layer or between the applied functional layer and the material surface. Particularly if the material surface is a cast material, pores may occur more frequently. The imperfections may also be cracks that run in particular vertically to the material surface within the applied functional layer. The imperfections may also result from the fact that powder particles, in particular carbides, of the powdered filler material dissolve in a matrix material of the powdered filler material, which leads to the matrix material becoming brittle. Embodiments of the invention provide a reliable jet nozzle that is resistant to thermal stresses. According to some embodiments, the jet nozzle is configure in such a way that it ensures reliable and precise laser cladding over a very high number of cycles.

Accordingly, a jet nozzle for laser cladding along a direction of advance is provided, which has a light channel for conducting at least one laser beam that is directed onto a workpiece. Laser cladding may comprise a method for high-speed laser metal deposition (HS-LMD). The direction of advance is the direction along which the jet nozzle moves relative to the workpiece. It may result from a movement, in particular a rotational movement, of the workpiece, from a movement of the jet nozzle, or from superimposition of the two movements. The direction of advance and the correlating advancing movement may be constant over the course of the process. Alternatively, they may vary with the respective process stage. The workpiece may be a rotationally symmetrical workpiece, such as a brake disk, a hydraulic cylinder, a pressure roller, or a plain bearing. The laser beam may be emitted through the light channel. It may be provided by a laser source, from which the laser beam is conducted by means of an optical fiber cable to a laser system that splits the laser beam via a collimating lens and focuses it appropriately via laser optics before it enters the jet nozzle. The light channel may be a hollow channel that runs through the entire jet nozzle along a longitudinal direction. In addition to the laser beam, a process gas may also be directed to the workpiece surface through the light channel.

The jet nozzle furthermore has a powder unit located radially outside the light channel for conducting at least one jet of powder to be applied to the workpiece. Starting from the longitudinal direction of the jet nozzle, the powder unit may be radially outside the light channel and may be part of an outer structure that surrounds the light channel in a closed manner. The jet of powder may convey at least one powdered filler material consisting of hard material particles, in particular carbides, and a matrix material. The powder unit may be the part of the jet nozzle that is provided to directly or indirectly conduct the powdered filler material. The powder unit may have injector guides into which powder injectors can be inserted. It may also have an annular gap within which the powdered filler material is conducted.

The powder unit forms a powder section at a mouth of the nozzle in a circumferential direction about the light channel and an advance section that is devoid of a powder unit is contiguous thereto in the circumferential direction. The powder unit may be part of the mouth of the nozzle. The mouth of the nozzle is the part of the jet nozzle facing the workpiece. The end section of the mouth of the nozzle has a distal region. This is the part of the mouth of the nozzle that is closest to the workpiece. At the section remote from the workpiece, the jet nozzle has a proximal region and a flange section. The proximal region and the flange section are the part of the jet nozzle remote from the workpiece. The nozzle can be coupled to another component of the laser system, such as laser optics or a process unit for example, via the flange section. The powder section and the advance section may together form the entire circumference of the mouth of the nozzle around the light channel. The powder section may, for example, constitute a larger part than the advance section. In plan view, the powder section and the advance section may extend in closed manner along an opening of the light channel.

The jet nozzle may thus provide increased variability in (i) laser beam guidance, (ii) the use of a powdered filler material, (iii) heat management and/or (iv) protection of the laser system including the jet nozzle. It enables the provision of a plurality of independent process zones with high precision. The process zones may be divided into zones for laser cladding and zones for pre-processing and/or post-processing. In the zones for laser cladding, an interaction takes place between at least one laser beam and a powdered filler material. Pre-processing and/or post-processing may include cleaning of the material surface, pre-heating of the material surface before the powdered filler material is applied, post-heating of the material surface after the powdered filler material has been applied, or a combination thereof. During pre-processing and/or post-processing, the laser beam may impinge on the workpiece without interacting with the powdered filler material. The independent process zones may enhance weld quality and thus increase the load-bearing capacity of the applied functional layer, in particular the wear protection layer, and of the workpiece as a whole. An additional process gas may stabilize the process zones and increase laser cladding precision as well as the service life of the jet nozzle.

In particular, the jet nozzle may reduce the occurrence of bonding defects. This is because bonding defects may occur if the surface heated by the laser beam, such as the workpiece or a previously welded-on functional layer, has not been sufficiently heated. This inadequate heating may be the result of the laser power of an individual laser beam being kept low to avoid overheating the powdered filler material. Due to the increased variability of laser beam guidance, the increased variability of the application of a powdered filler material and/or the increased variability of heat management of the jet nozzle, the occurrence of bonding defects may be reduced or even prevented, in particular by the jet nozzle being divided into a powder section and an advance section, which enables the provision of multiple process zones.

In particular, the jet nozzle may also reduce the occurrence of pores between the welded-on functional layer and the surface heated by the laser beam. This is because pores may occur when lamellae in the workpiece, in particular graphite lamellae, are vaporized by the laser radiation. Pores may also occur if the surface to be processed has impurities, for example caused by oils, greases, cooling lubricants or oxides, which cannot be completely removed by the welding process. The undesired vaporization of the impurities may be the result of the laser power of an individual laser beam being set sufficiently high to prevent bonding defects due to insufficient heating. Due to the increased variability of laser beam guidance, the increased variability of the application of a powdered filler material and/or the increased variability of heat management of the jet nozzle, the occurrence of pores may be reduced or even prevented, in particular by the jet nozzle being divided into a powder section and an advance section, which enables the provision of multiple process zones.

In particular, the jet nozzle may also reduce the occurrence of cracks in the welded-on functional layer. This is because cracks may occur if the temperature gradient between the strongly heated powdered filler material and the less strongly heated workpiece surface is so great that the material shrinkage that occurs during cooling results in stresses that cause cracks. Cracking may be the result of the laser power of an individual laser beam being set sufficiently high to prevent bonding defects due to insufficient heating. Due to the increased variability of laser beam guidance, the increased variability of the application of a powdered filler material and/or the increased variability of heat management of the jet nozzle, the occurrence of cracks may be reduced or even prevented, in particular by the jet nozzle being divided into a powder section and an advance section, which enables the provision of multiple process zones.

Moreover, the jet nozzle may in particular reduce the dissolution of hard material particles, especially carbides, in the matrix material. The powdered filler material may include hard material particles, in particular carbides, and a matrix material. The hard material particles should be present undissolved in the welded-on functional layer to increase the load-bearing capacity of the functional layer. However, hard material particles may dissolve if the powdered filler material is exposed to too high a radiation intensity, causing the hard material particles to melt. Dissolved hard material particles cause the welded-on functional layer to become brittle because the matrix material is less ductile, which means that stresses caused by shrinkage, for example, cannot be absorbed by the matrix material when the workpiece is cooled or loaded. Due to the increased variability of laser beam guidance, the increased variability of the application of a powdered filler material and/or the increased variability of heat management of the jet nozzle, the dissolution of hard material particles may be reduced or even prevented, in particular by the jet nozzle being divided into a powder section and an advance section, which enables the provision of multiple process zones.

Moreover, the jet nozzle may in particular prevent adhesion of powder particles to the mouth of the nozzle. In principle, the high process heat may, due to reflective laser radiation and/or due to a metal vapor plume, cause adhesion or even welding of filler material to the mouth of the nozzle, which can disrupt the gas and powder flows and consequently impair the process result. The metal vapor plume is a result of partial vaporization of the material due to laser cladding. It may lead to scattering and/or absorption of laser radiation and consequently impair preheating of the workpiece. This may further promote the formation of bonding defects. Due to the increased variability of laser beam guidance, the increased variability of the application of a powdered filler material and/or the increased variability of heat management of the jet nozzle, the undesirable dissolution of hard material particles and propagation of the metal vapor flare may be reduced or even prevented, in particular by the jet nozzle being divided into a powder section and an advance section, which enables the provision of multiple process zones.

At least one laser beam, in particular at least one circular laser beam and/or one oval laser beam, can be guided within the mouth of the nozzle in such a way that, in interaction with the powdered filler material, more than one process zone is formed, which promotes welding behavior, reduces the imperfections of the welded joint, in particular the occurrence of bonding defects, pores, cracks and/or the dissolution of carbides in the matrix material, and increases the load-bearing capacity of the applied functional layer. This means that the melting behavior, powder jet behavior, material bonding and cooling behavior can be variably adapted to the respective application and the prevailing material properties and process parameters. In particular, the powdered filler material can be prevented from being exposed to too much laser power. Accordingly, the powdered filler material is not overheated in interaction with the laser beam, so preventing vaporization and powder loss, for example. Furthermore, the temperature gradient of the molten material is less due to the advance section, resulting in less shrinkage and lower internal stress, which prevents the occurrence of cracks in the functional layer. The division into a powder section and an advance section may also create a gap in the powder caustic, which further contributes to the different process zones. The division into a powder section and an advance section enables welding behavior without the aforementioned imperfections.

In one embodiment, the advance section is formed in a region of the mouth of the nozzle facing the direction of advance. In plan view, the region of the mouth of the nozzle facing the direction of advance is provided at the end of the nozzle that is close to the direction of advance. One end face of the advance section points in the direction of the workpiece. The advance section may extend along the circumferential direction around the light channel over an angular range. The angular range over which the advance section extends may be smaller than the angular range over which the powder section extends. The region in which the advance section is formed may correlate with the position and orientation of the powder injectors that apply the powdered filler material to the workpiece.

In one embodiment, the powder section extends along an elongated hole arc, in particular in the shape of a horseshoe, around the light channel. Similar to a circular arc, the elongated hole arc represents a line surrounding the elongated hole in one sector. The remaining part of the elongated hole that is not taken up by the elongated hole arc along which the powder section extends may be taken up by the advance section. The powder section may extend at least partly along the two opposing, straight ends of the elongated hole and the intermediate circle segment section to form the horseshoe shape. This further contributes to the possibility of providing more than one process zone.

In one embodiment, the powder section extends in the circumferential direction around the light channel over a wrap angle of between 45° and 330°, in particular between 90° and 300°, further in particular between 180° and 300°, relative to a center of the light channel. The powder section may therefore extend by a larger section around the light channel than the advance section. In this way, satisfactory powder supply can be ensured by the powder unit and, in particular, injectors arranged therein. Precise adaptation of the powder section and the advance section to the respective process conditions enables efficient welding behavior without imperfections. In particular, if the mouth of the nozzle has a chamfer that cuts off part of the mouth of the nozzle, the wrap angle of the powder section is between 90° and 180°. If the mouth of the nozzle has no chamfer, the mouth of the nozzle is preferably above 180°.

In one embodiment, the powder section is composed of a first powder section and a second powder section, and the first powder section is separated from the second powder section by a powder section gap. The powder section gap may be different from the advance section. Through the powder section being composed of a plurality of individual powder sections, further account is taken of the variability of the jet nozzle. The composition of the powder section may be determined in interaction with the configuration of the laser beam or laser beams.

In one embodiment, the powder section gap is formed in a region of the mouth of the nozzle remote from the advance direction. The advance section may thus be arranged facing the advance direction and the powder section gap may be arranged remote from the advance direction. Especially when the light channel conducts more than one, especially three, laser beams, the division of the powder section into multiple powder sections in interaction with the advance section and the powder section gap may further contribute to the jet nozzle being able to achieve efficient welding behavior without imperfections.

In one embodiment, the powder section has a plurality of injector guides, into each of which a powder injector may be inserted. The injector guides may be cylindrical or conical through-openings in the region of the mouth of the nozzle, into each of which a powder injector may be inserted. The injector guides may be introduced into the mouth of the nozzle by machining. Preferably, however, they are provided at the stage of additive manufacturing of the jet nozzle. The injector guides may be adapted to the powder injector to be used.

In one embodiment, a first powder injector is prepared to convey a first powder mass flow and a second powder injector is prepared to convey a second powder mass flow, wherein the first powder mass flow differs from the second powder mass flow. The first powder injector may be provided in the first powder section, and the second powder injector in the second powder section. The first powder injector may be arranged in such a way that it interacts with a primary beam of the laser beam. The second powder injector may be arranged in such a way that it interacts with a secondary beam of the laser beam. The primary beam and the secondary beam may be identical to one another or transport different energies. Provision of the first powder mass flow and the second powder mass flow enables the jet nozzle to achieve more than one process zone, which further contributes to increased variability of the jet nozzle.

In one embodiment, the first powder mass flow conveys a powder that differs from the second powder mass flow. This allows a functional layer with variable materials to be applied to the workpiece. Alternatively, the first powder mass flow and the second powder mass flow may direct the same powder onto the workpiece. Adapting the powder mass flow to the respective injectors to be supplied further contributes to increased variability.

In one embodiment, a first powder injector is prepared to form a first powder focus and a second powder injector is prepared to form a second powder focus, wherein the first powder focus differs from the second powder focus. A powder focus may be the location where the powder jet impinges on the workpiece. The powder focus lies in a radial direction within the cross-sectional area of the light channel. A plurality of first powder injectors may be adapted to form the first powder focus and equally a plurality of second powder injectors may be adapted to form the second powder focus. Thus, for example, a first laser deposition and a second laser deposition offset thereto along the advance direction may be welded onto the workpiece. Adaptation of the powder focus may be carried out as a function of the particular workpiece or the particular process and further contributes to increased variability.

In one embodiment, the powder section forms an annular gap segment, in particular instead of injector guides. The annular gap segment may form a uniform powder focus which, for example, coincides with the center of the at least one laser beam. In the case of an annular gap segment, the powdered filler material is applied to the workpiece along a horseshoe-shaped jet.

In one embodiment, the jet nozzle is manufactured using an additive manufacturing process, in particular using powder bed fusion. For this purpose, the jet nozzle may be made of copper or a copper alloy, in particular a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is present in powder form. A laser beam heats the powder along the intended geometry, causing the powder to liquefy and form a material bond. The powder bed fusion may take the form, for example, of selective laser melting (SLM) or selective laser sintering (SLS).

In one embodiment, the mouth of the nozzle has a chamfer that cuts off part of the mouth of the nozzle, wherein the chamfer is substantially flat and extends in a plane which is inclined relative to the longitudinal direction of the jet nozzle. The chamfer may cut off the powder section and the powder section-free advance section in the circumferential direction around the light channel. The chamfer reduces the volume of the mouth of the nozzle compared to the embodiment in which no chamfer is provided. This means that the mouth of the nozzle takes up less installation space. The jet nozzle with the chamfer can be used, for example, to coat a brake disk that has a holder that protrudes axially relative to the functional surface to be coated. The chamfer ensures that the jet nozzle can move flexibly on the functional surface to be coated and can be moved close to the holder. In the distal region the chamfer may pass the elongated hole in the manner of a passant. The passant defines the orientation of the chamfer at the mouth of the nozzle. In the end face of the jet nozzle facing the workpiece, the passant runs along a straight line or an arc that neither intersects nor touches the elongated hole. The distance of the passant from the center of the light channel is greater than the distance of the corresponding section of the elongated hole from the center of the light channel. The distance between the passant and an outer edge of the elongated hole is selected in such a way that the wall thickness in between ensures sufficient sturdiness and stressability of the jet nozzle.

In one embodiment, the jet nozzle is adapted to guide the laser beam along the longitudinal direction of the jet nozzle, such that the at least one laser beam is orthogonal to the cross-sectional area. Furthermore, the light channel may be adapted to conduct a shielding gas along a radially outer section to shield a process zone.

The features according to the disclosure contribute partly on their own and partly in combination to overcoming the imperfections of laser cladding mentioned at the outset.

Exemplary embodiments are described below with reference to the figures. In this case, elements that are the same, similar, or have the same effect are provided with identical reference signs in the different figures, and a repeated description of these elements is omitted in some instances to avoid redundancies.

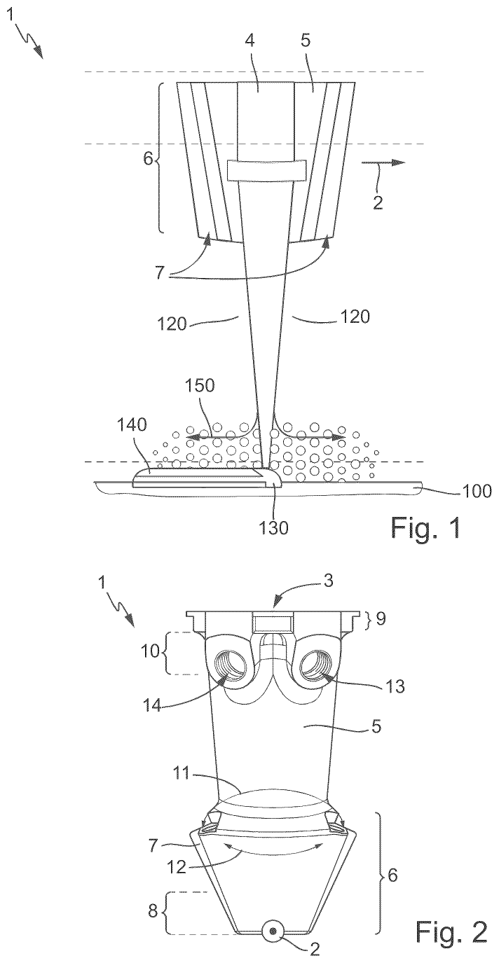

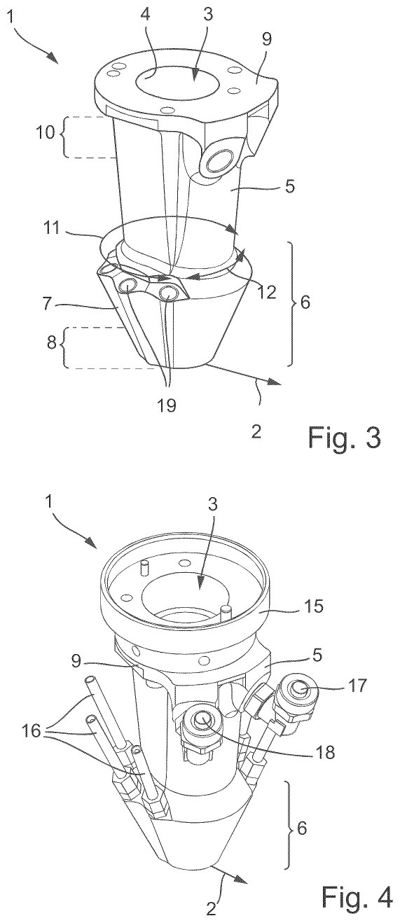

FIG. 1 shows a jet nozzle 1 for laser cladding along a direction of advance 2. The direction of advance 2 is the direction along which the jet nozzle 1 moves relative to a workpiece 100. It may result from a movement, in particular a rotational movement, of the workpiece 100, from a movement of the jet nozzle 1 or from superimposition of a movement of the workpiece 100 and the jet nozzle 1. The direction of advance 2 and the correlating advancing movement may be constant over the course of the process. Alternatively, they may vary with the respective process stage. The workpiece 100 may be a rotationally symmetrical workpiece, such as a brake disk, a hydraulic cylinder, a pressure roller, or a plain bearing. At least one laser beam 110 emerges from a light channel 3 with a lateral surface 4. The light channel 3 may also be adapted to conduct a process shielding gas 150 along a radially outer section to shield a process zone and prevent oxidation. The light channel 3 is surrounded by an outer structure 5, which has a mouth 6 of the nozzle, which in turn contains a powder unit 7. The powder unit 7 may, for example, have a plurality of injector guides 19 (see FIG. 3), into each of which a powder injector 16 may be inserted (see FIG. 4). As an alternative to the individual injector guides 19, the powder unit 7 may have an annular gap powder channel. A powdered filler material 120 is directed onto the workpiece 100 via the powder unit 7 and the powder injectors 16 arranged therein. The laser beam 110 heats the workpiece 100 in such a way that a melt pool 130 forms on a material surface. In addition, the laser beam 110 heats the powdered filler material 120, which includes hard material particles and a matrix material. For this purpose, the laser beam 110 may have a reduced core intensity. As soon as the melt pool 130 cools down, a welded-on functional layer 140, for example a wear protection layer, is formed from the hard material particles and the matrix material. The welded-on functional layer 140 makes the material surface more resistant and increases its load-bearing capacity.

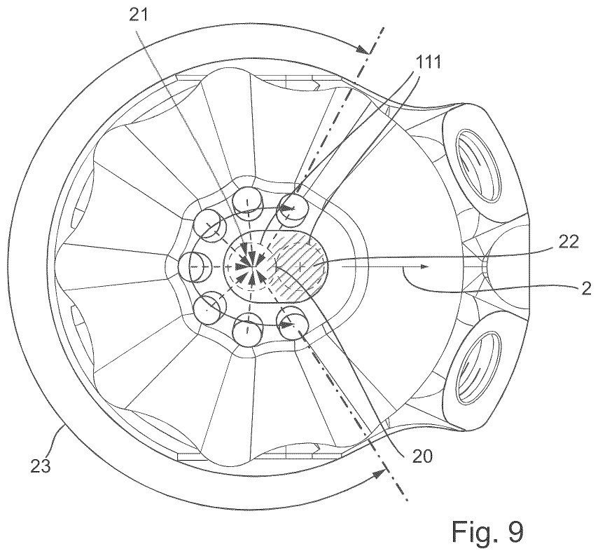

FIG. 2 shows a side view of the jet nozzle 1, with the direction of advance 2 pointing out of the drawing plane. The jet nozzle 1 can be coupled to other components of a laser system, such as laser optics or a process adapter for example, via a flange section 9. A proximal region 10 adjoins the flange section 9. A coolant inlet 13 and a coolant outlet 14, which are part of a cooling system of the jet nozzle 1 and which project radially from the jet nozzle 1, can be provided at least partly in the proximal region 10. A distal region 8 is formed at the end of the jet nozzle 1 opposite the proximal region 10. The distal region is part of the funnel-shaped mouth 6 of the nozzle. In places in a circumferential direction around the light channel 3, this has a powder section 11 in which the powder unit 7 is arranged. In the circumferential direction the powder section 11 is adjoined by an advance section 12 devoid of a powder unit. The advance section 12 may be configured as a process gas section 61 (see, for example, FIG. 9), which is part of a process gas unit 60.

FIG. 3 shows a perspective view of the jet nozzle of FIG. 2. The light channel 3 is a hollow channel with a lateral surface 4, within which the at least one laser beam 110 extends. The outer structure 5 surrounds the light channel 3 from the flange section 9 to the distal region 10. The mouth 6 of the nozzle is a substantially funnel-shaped region of the jet nozzle 1. The funnel shape of the mouth 6 of the nozzle serves, among other things, to enable the mouth 6 of the nozzle to form the plurality of injector guides 19 in the region of the powder unit 7. A powder injector 16 (see FIG. 4) is inserted into each of these injector guides 19 and directs the powdered filler material 120 appropriately onto the at least one laser beam 110 and/or the workpiece 100. The powder unit 7 extends along the powder section 11, which is adjoined in the circumferential direction by the advance section 12 devoid of a powder unit. The advance section 12 is the region of the mouth 6 of the nozzle in which no injector guides 19 are provided, such that no powdered filler material 120 is supplied via this section. In one embodiment, the advance section 12 may take the form of a process gas section 61, such that a process gas is supplied via it. The jet nozzle 1 may be manufactured using additive manufacturing processes, in particular using powder bed fusion. For this purpose, the jet nozzle 1 may be made of a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is present in powder form. A laser beam heats the powder along the intended geometry, causing the powder to liquefy and form a material bond. The powder bed fusion may take the form, for example, of selective laser melting (SLM) or selective laser sintering (SLS).

FIG. 4 shows the jet nozzle 1, to which additional components have been attached. For instance, a coupling ring 15, which attaches the jet nozzle 1 to the connected unit, for example the laser optics or the process adapter, is connected to the flange section 9. Powder injectors 16 are inserted into the injector guides 19 of the powder unit 7. The powdered filler material 120 is conveyed by means of the powder injectors 16 and applied to the workpiece 100 with the intended focus. The individual powder injectors 16 may use mutually different powder foci. Alternatively, the powder injectors 16 may be directed to the same focal point. The powder injectors 16 are arranged in the powder section 11 in the injector guides 19 provided therefor of the powder unit 7. The advance section 12 is free of powder injectors 16. An inlet connection 17 is further inserted into the coolant inlet 13 and an outlet connection 18 into the coolant outlet 14. These connect the coolant inlet 13 and the coolant outlet 14 to a coolant circuit.

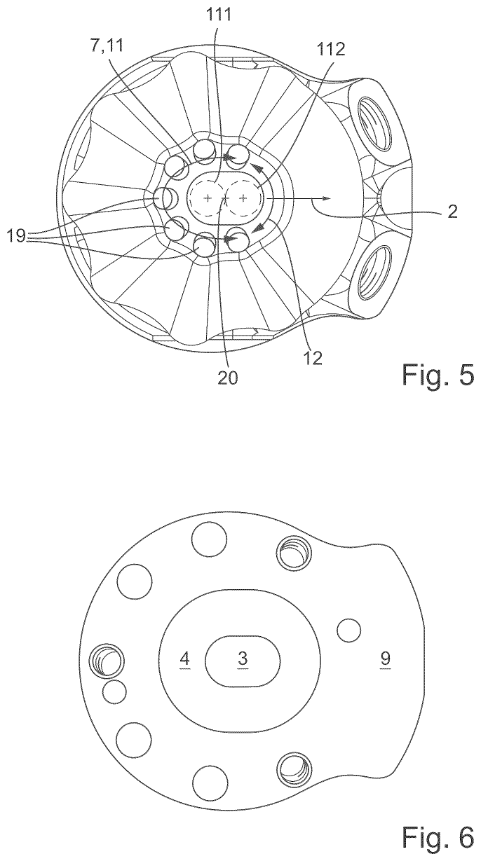

FIG. 5 shows a plan view of the distal region 8 of the jet nozzle 1. The cross-sectional area of the light channel 3 which is orthogonal to the longitudinal direction of the jet nozzle 1 deviates from a circular shape and is extended in the direction of advance 2. In the distal region 8, the cross-sectional area of the light channel 3 takes the form of an elongated hole, where a circle segment section in each case adjoins two opposing ends of a rectangular section. Two laser beams are guided within the light channel 3, a primary beam 111 and a secondary beam 112. The primary beam 111 and the secondary beam 112 may originate from the same optical fiber cable. The laser light provided can be split into a parallel beam via a collimating lens. The beam may, for example, form the primary beam 111 and the secondary beam 112 from a single laser beam using a wedge plate. The respective centers of the primary beam 111 and the secondary beam 112 lie in the direction of advance 2 in a line offset relative to a center 20 of the light channel 3.

In the present case, the secondary beam 112 lies in front of the primary beam 111 in the direction of advance 2 and does not interact with a powder caustic. The secondary beam 112 can thus be used to preheat the workpiece 100 before the primary beam 111 and the powdered filler material 120 heated by the primary beam 111 impinge on the workpiece 100. The secondary beam 112 thus creates a first process zone, which serves to preheat the workpiece 100, and the primary beam 111 creates a second process zone, which serves to weld the powdered filler material 120 onto the workpiece 100. These different process zones enable a flawless weld in which no imperfections occur, in particular no bonding defects, pores, cracks and/or dissolution of carbides in the matrix material. It is also possible to guide the secondary beam 112 in the direction of advance 2 after the primary beam 111. Thus, the secondary beam 112 can be used to reheat the workpiece 100, contributing to more uniform cooling that prevents the occurrence of inclusions or other imperfections.

The primary beam 111 and the secondary beam 112 are arranged in close proximity to one another. The front circle segment section of the elongated hole in the direction of advance 2 is concentric to the secondary beam 112, while the rear circle segment section of the elongated hole is concentric to the primary beam 111. A center of the cross-sectional area is eccentric relative to a center of the primary beam 111 and to a center of the secondary beam 112. A tertiary beam can also be provided such that, for example, the secondary beam is arranged before the primary beam in the direction of advance and the tertiary beam is arranged after the primary beam in the direction of advance. The individual laser beams are guided relative to one another without shielding, such that there is precisely one light channel 3 with precisely one lateral surface 4, which results in minimal thermal losses.

Because the primary beam 111 in FIG. 5 is arranged behind the secondary beam 112 in the direction of advance 2 without radial offset and the secondary beam 112 serves to preheat the workpiece, it is desirable for the powdered filler material not to interact with the secondary beam 112. This ensures that, on the one hand, the secondary beam 112 can only perform the function of preheating the workpiece and, on the other hand, the powdered filler material is only heated by the primary beam 111 and not by the secondary beam 112. This is achieved by the jet nozzle 1 forming the powder unit 7 in the region of the mouth 6 of the nozzle in such a way that the powder unit forms the powder section 11 in the circumferential direction around the light channel 3, which powder section is adjoined in the circumferential direction by the advance section 12 devoid of a powder unit. In addition to the powder unit 7, the process gas unit 60, which forms the process gas section 61, can also be formed, in which case the advance section 12 takes the form of the process gas section 61. The advance section 12 is formed in a region of the mouth 6 of the nozzle facing the direction of advance 2. The powder section 11 extends along the elongated hole that forms the cross-sectional area of the light channel 3 in the distal region 8. Similar to a circular arc, the powder section 11 extends along an elongated hole arc, in particular in the shape of a horseshoe, around the light channel 3. The powder section 11 therefore extends in the circumferential direction around the light channel 3 over a wrap angle of less than 360°, in particular of between 90° and 330°, further in particular between 180° and 300°, relative to a center of the light channel. This ensures that the powdered filler material flowing out of the injectors 16, which are inserted in the injector guides 19, only interacts with the primary beam 111. The secondary beam 112 is thus able to form a process zone independent of the primary beam 111. The powder section 11 and the advance section 12 form an elongated hole shape when viewed in plan view. This also helps to reduce or avoid the imperfections identified at the outset.

FIG. 6 shows a plan view of the flange section 9 of the jet nozzle 1. The cross-sectional area of the light channel 3 which is orthogonal to the longitudinal direction of the jet nozzle 1 also deviates from a circular shape in the region of the flange section 9 and is extended in the direction of advance 2. The extension of the cross-sectional area may decrease from the distal region 8 to the flange section 9. In the region of the mouth 6 of the nozzle, the cross-sectional area can be extended in such a way that it is at least 1.5 times larger in the direction of advance, in particular at least twice as large, as transversely of the direction of advance. The flange section 9 has such a radial extent that the injector guides 19 are not visible in plan view onto the proximal region 10.

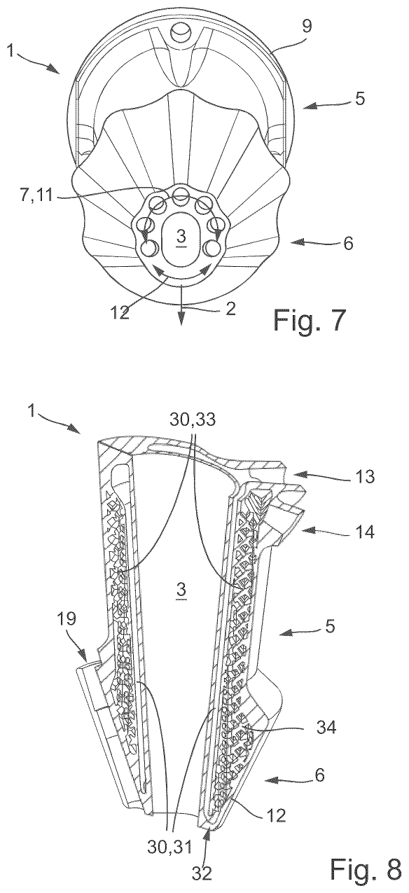

FIG. 7 shows a further perspective view of the jet nozzle 1. The mouth 6 of the nozzle has a curved funnel shape. The injector guides 19, into which the powder injectors 16 can be inserted, are formed within the individual curvatures. In the direction of advance 2, the light channel is extended in a way that deviates from a circular shape to achieve the advantages according to the disclosure. In the circumferential direction around the light channel 3, the mouth 6 of the nozzle has the powder unit 7. This extends in the circumferential direction around the light channel 3 along the powder section 11, which is adjoined by the powder-free advance section 12.

FIG. 8 shows a perspective sectional view of the jet nozzle 1. The light channel 3 has a conical shape, such that the cross-sectional area of the light channel 3 running orthogonal to the longitudinal direction of the jet nozzle 1 is smaller in the distal region 8 than in the proximal region 10. The coolant inlet 13 and the coolant outlet 14 are arranged in the proximal region 10 of the jet nozzle 1 and protrude in a radial direction from the jet nozzle 1. FIG. 8 shows a sectional view of an injector guide 19. This is arranged in the powder section 11. No injector guide 19 for powder jet guidance is provided in the advance section 12. The jet nozzle 1 has a cooling system 30. A cooling medium, for example water, is returned to a radially inner cooling chamber 31 via the coolant inlet 13 in the proximal region 10. The cooling medium may be distributed in the proximal region 10 in the circumferential direction around the light channel 3. The cooling medium runs from the proximal region 10 to the mouth 6 of the nozzle. The radially inner cooling chamber 31 is formed at least in the mouth 6 of the nozzle. It can extend from the distal region 8 to the proximal region 10 and take the form of an annular gap segment that extends circumferentially around light channel 3. In the region of the mouth 6 of the nozzle, the radially inner cooling chamber 31 extends circumferentially around the light channel 3. The radially inner cooling chamber 31 has a constant width in the radial direction in the region of the mouth 6 of the nozzle and is concentric to the light channel 3 in a cross-sectional area extending orthogonally to a longitudinal direction of the jet nozzle 1.

A transition 32 between the radially inner cooling chamber 31 and a radially outer cooling chamber 33 is provided in the distal region 8. The radially outer cooling chamber 33 has a radial width that decreases towards the distal region 8 in the radial direction in the region of the mouth 6 of the nozzle. The radially outer cooling chamber 33 extends from the distal region 8 to the proximal region 10, where it feeds the heated coolant to the coolant outlet 14. The transition 32 between the radially inner cooling chamber 31 and the radially outer cooling chamber 33 is arranged in the advance section 12. The advance section 12 has no injector guides 19 for powder jet guidance, which means that there is sufficient installation space for the transition 32.

The radially outer cooling chamber 33 has a cooling structure to increase the surface area. The cooling structure may be produced using an additive manufacturing process. It ensures that the cooling medium comes into contact with as much surface area as possible on return from the distal region 8 to the proximal region 10 to promote heat dissipation. The cooling structure is optimized to cause the lowest possible cooling medium pressure losses. This can be achieved by a honeycomb structure 34, as shown in FIG. 8.

FIG. 9 shows the above-described behavior that the powder section 11 with the injector guides 19 forms a first powder focus 21 which coincides with the center of the primary beam 111. The injectors 16 have a common focal point in the first powder focus 21. Individual injectors are also in each case opposite one another at the first powder focus 21 in diametrically mirrored manner. This enables the jet nozzle 1 to efficiently apply the powdered filler material to the workpiece via the primary beam 111. In the region of the secondary beam 112 there is a gap 25 in the powder caustic, which is highlighted in FIG. 9 by hatching. The position of the first powder focus 21 as well as the position of the gap 25 in the powder caustic can be adjusted via an arrangement of the powder unit 7 and its powder section 11 as well as an arrangement of the advance section 12. The gap 25 in the powder caustic can be substantially half the size of the cross-sectional area of the light channel 3 in the distal region 8. This ensures that the secondary beam 112 does not interact with the powdered filler material 120. The relationship of the powder section 11 to the advance section 12 and their arrangement in the circumferential direction of the light channel 3 results in a wrap angle 26 over which the powder section extends around the center point 20 of the light channel 3. This lies between 90° and 330°, in particular between 180° and 300°, relative to the center point 20 of the light channel 3.

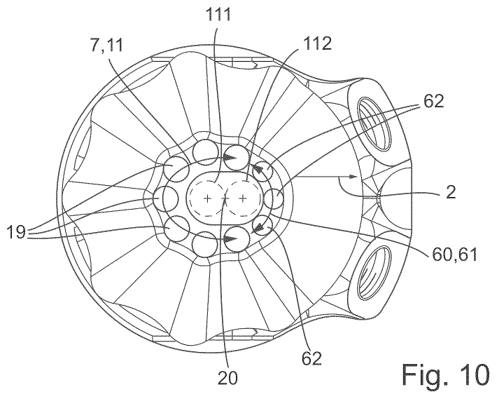

FIG. 10 shows a plan view of the distal region 8 of the jet nozzle 1. The primary beam 111 and the secondary beam 112 are guided within the light channel 3. The secondary beam 112 is in front of the primary beam 111 in the direction of advance 2 and does not interact with a powder caustic, as described in more detail in connection with FIG. 5. When the laser beams interact with the material surface and the jet of powder, a vapor plume may form between the jet nozzle 1 and the workpiece 100. If this is not contained, it can interact in an undesirable manner with at least one laser beam and/or the unprocessed and/or processed material surface. In the region adjacent to the powder section 11, the advance section 12 may therefore be configured as a process gas section 61. This is formed by the process gas unit 60 arranged radially outside the light channel 3, which directs the process gas onto the workpiece. The process gas section 61 can prevent undesired spreading of the vapor plume and thus contribute to precise workpiece processing with a robust jet nozzle design. The process gas section 61 may form at least one, in the present case three, outlet openings 62. The outlet openings 62 are formed at one end face of the jet nozzle 1. An additional injector for supplying the process gas without filler material may be inserted into the respective outlet opening 62. An internal diameter of the outlet opening 62 may be smaller than an internal diameter of the injector guides 19. The process gas section 61 also prevents powder particles from adhering to the end face of the jet nozzle 1. In this respect, the process gas section 61 also increases the service life of the jet nozzle 1. The process gas section 61 and the powder section 11 may be provided circumferentially around the elongated hole formed by the light channel 3. The primary beam 111 and the secondary beam 112 are thus completely within the jets composed of the jet of powder and the process gas jet.

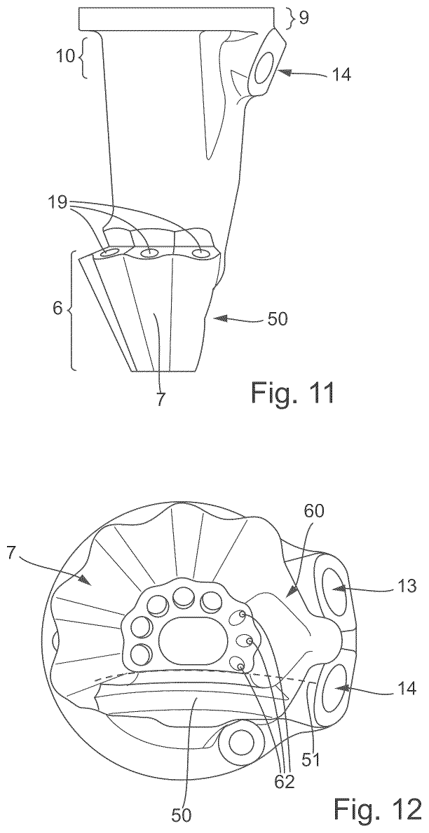

FIG. 11 shows a further embodiment of the jet nozzle 1. The mouth 6 of the nozzle has a chamfer 50 that cuts off part of the mouth 6 of the nozzle. The chamfer 50 has the effect of cutting off the powder section 11 and the powder section-free advance section 12 in the circumferential direction around the light channel 3. The chamfer 50 reduces the volume of the mouth 6 of the nozzle compared to the embodiment in which there is no chamfer 50. This ensures that the mouth 6 of the nozzle takes up less installation space. The jet nozzle 1 with the chamfer 50 can be used, for example, to coat a brake disk. The brake disk may have a holder that protrudes axially relative to the functional surface to be coated. The chamfer 50 ensures that the jet nozzle 1 can move flexibly on the functional surface to be coated and can be moved close to the holder. The chamfer 50 may be substantially flat and extend in a plane which is inclined relative to the longitudinal direction of the jet nozzle. The chamfer 50 represents a boundary surface of the mouth 6 of the nozzle in which no powder unit 7 is provided. In the distal region 8, the chamfer 50 is arranged so close to the light channel 3 that no injector guides 19 are provided at an end face of the jet nozzle 1 facing the workpiece in the region of the chamfer 50.

FIG. 12 shows a plan view of the jet nozzle 1 with the chamfer 50. The chamfer 50 may pass the elongated hole in the distal region 8 in the manner of a passant 51. The passant 51 defines the orientation of the chamfer 50 at the mouth 6 of the nozzle. In the end face of the jet nozzle 1 facing the workpiece, the passant 51 runs along a straight line or an arc that neither intersects nor touches the elongated hole. The distance of the passant 51 from the center 20 of the light channel 3 is greater than the distance of the corresponding section of the elongated hole from the center 20 of the light channel 3. The distance between the passant 51 and an outer edge of the elongated hole is selected in such a way that the wall thickness in between ensures sufficient sturdiness and stressability of the jet nozzle 1.

The orientation of the passant 51 and thus the orientation of the chamfer 50 at the mouth 6 of the nozzle can be varied for different jet nozzles 1 depending on the respective application. For example, the passant 51 may extend in the direction of advance 2. In this case, the passant 51 extends along the extension of the cross-sectional area of the light channel 3. The passant 51 thus extends along the long side of the elongated hole. Alternatively, the passant 51 may extend transversely of the direction of advance 2, for example. In this case, the passant 51 extends transversely of the extension of the cross-sectional area of the light channel 3. The passant 51 thus extends along the circle segment section of the elongated hole. As a further alternative, the passant 51 may, for example, run at an angle to the direction of advance 2 that lies between a course along the direction of advance 2 and transversely of the direction of advance 2. In this case, the passant 51 runs along the transition section between the long side of the elongated hole and the circle segment section of the elongated hole. The course of the passant 51 determines the orientation of the chamfer 50.

In the embodiment of FIG. 12, outlet openings 62 are provided at the end face of the jet nozzle. The process gas exits the process gas unit 60 from these outlet openings. In the present case, the chamfer 50 is such that the portion of the mouth 6 of the nozzle cut off thereby originates entirely from the powder section 11, such that the angle along which the powder section 11 extends is reduced by the chamfer 50, while the angle along which the process gas unit 60 extends remains substantially the same.

Insofar as applicable, all individual features presented in the exemplary embodiments can be combined with one another and/or interchanged.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Jet nozzle
2 Direction of advance
3 Light channel
4 Lateral surface
5 Outer structure
6 Mouth of the nozzle
7 Powder unit
8 Distal region
9 Flange section
10 Proximal region
11 Powder section
12 Advance section
13 Coolant inlet
14 Coolant outlet
15 Coupling ring
16 Powder injector
17 Inlet connection
18 Outlet connection
19 Injector guide
20 Center of the light channel
21 First powder focus
25 Gap in powder caustic
26 Wrap angle
30 Cooling system
31 Radially inner cooling chamber
32 Transition
33 Radially outer cooling chamber
34 Honeycomb structure
50 Chamfer
51 Passant
60 Process gas unit
61 Process gas section
62 Outlet opening
100 Workpiece
110 Laser beam
111 Primary beam
112 Secondary beam
120 Powdered filler material
130 Melt pool
140 Functional layer

1. A jet nozzle for laser cladding along a direction of advance, the jet nozzle comprising:
a light channel for conducting at least one laser beam directed onto a workpiece; and
a powder unit located radially outside the light channel for conducting at least one jet of powder to be applied to the workpiece;
wherein the powder unit forms a powder section at a mouth of the jet nozzle in a circumferential direction about the light channel, and an advance section that is devoid of the powder unit is contiguous thereto in the circumferential direction.

2. The jet nozzle according to claim 1, wherein
the advance section is formed in a region of the mouth of the jet nozzle facing the direction of advance.

3. The jet nozzle according to claim 1, wherein
the powder section extends along an elongated hole arc around the light channel.

4. The jet nozzle according to claim 1, wherein
the powder section extends in the circumferential direction around the light channel over a wrap angle of between 45° and 330°, relative to a center of the light channel.

5. The jet nozzle according to claim 1, wherein
the powder section comprises a first powder section and a second powder section, the first powder section is separated from the second powder section by a powder section gap.

6. The jet nozzle according to claim 5, wherein
the powder section gap is formed in a region of the mouth of the jet nozzle remote from the advance direction.

7. The jet nozzle according to claim 1, wherein
the powder section has a plurality of injector guides, into each of which a respective powder injector is capable of being inserted.

8. The jet nozzle according to claim 7, wherein
a first powder injector is configured to convey a first powder mass flow. and a second powder injector is configured to convey a second powder mass flow, wherein the first powder mass flow differs from the second powder mass flow.

9. The jet nozzle according to claim 8, wherein
the first powder mass flow conveys a powder that differs from the second powder mass flow.

10. The jet nozzle according to claim 7, wherein
a first powder injector is configured to form a first powder focus, and a second powder injector is configured to form a second powder focus, wherein the first powder focus differs from the second powder focus.

11. The jet nozzle according to claim 1, wherein
the powder section forms an annular gap segment.

12. The jet nozzle according to claim 1, wherein the jet nozzle is manufactured using an additive manufacturing process and comprises copper or a copper alloy.

13. The jet nozzle according to claim 1, wherein
the mouth of the nozzle has a chamfer that cuts off part of the mouth of the jet nozzle, wherein the chamfer is substantially flat and extends in a plane which is inclined relative to a longitudinal direction of the jet nozzle.
